(19) United States
(12) Patent Application Publication
(10) Pub. No.: US 2023/0384534 A1
(43) Pub. Date: Nov. 30, 2023

(54) METHODS OF FERRULE RESHAPING FOR DIRECT LOCKING OPTICAL FIBERS AND CORRECTING CORE-TO-FERRULE ECCENTRICITY ERRORS

(71) Applicant: CORNING RESEARCH & DEVELOPMENT CORPORATION, Corning, NY (US)

(72) Inventors: Xinghua Li, Horseheads, NY (US); Correy Robert Ustanik, Davidson, NC (US); Lei Yuan, Painted Post, NY (US)

(21) Appl. No.: 18/321,307

(22) Filed: May 22, 2023

Related U.S. Application Data
(60) Provisional application No. 63/346,478, filed on May 27, 2022.

(51) Int. Cl. G02B 6/38; G02B 6/36

(52) U.S. Cl. CPC G02B 6/3862; G02B 6/3624; G02B 6/3843

(57) ABSTRACT

The present disclosure relates to laser treatment of a ferrule to secure an optical fiber within a ferrule bore. In particular, the laser treatment modifies the physical structure of the ferrule to aid in securing the optical fiber within the ferrule bore.

### PRIORITY APPLICATION

This application claims the benefit of priority of U.S. Provisional Application No. 63/346,478, filed on May 27, 2022, the content of which is relied upon and incorporated herein by reference in its entirety.

### FIELD

The present disclosure relates to optical fiber cable assemblies, and in particular relates to methods of ferrule reshaping for securing optical fibers within ferrules used in optical fiber connectors.

### BACKGROUND

Optical fiber connectors (“connectors”) are devices used to optically connect one optical fiber to another, or to connect an optical fiber to another device such as an optical transmitter or an optical receiver. An optical fiber cable typically carries the optical fiber, which has relatively high-index core section in which most of the light is carried, and a surrounding relatively low-index cladding section that surrounds the core. A ferrule in the connector supports a bare end section of the optical fiber. The bare end section has a polished end face that coincides with a planar front face of the ferrule. The connector and the optical fiber cable constitute a cable assembly.

When assembling optical fiber connectors, optical fibers are inserted into bores of ferrules, and a bonding agent is used to secure the optical fibers within ferrules. In particular, in some instances, the bonding agent is stored within the ferrule, but in other instances, the bonding agent is injected into the ferrule when the optical fiber is inserted. To insert the optical fiber, the ferrule is heated to expand the ferrule and ferrule bore and to melt a portion of the bonding agent (that is either already stored within the ferrule bore or injected into the ferrule bore). While the ferrule is expanded, the optical fiber is inserted through the ferrule bore and the bonding agent. Then, the ferrule cools to room temperature, thereby, contracting the ferrule, and locking the optical fiber within the ferule.

The above described process has manufacturing and operating costs associated with the processing steps outlined above and the raw material costs of the bonding agent. It would be advantageous to reduce these costs while still effectively inserting optical fibers within ferrules.

### SUMMARY

The present disclosure relates to laser treatment of a ferrule to secure an optical fiber within a ferrule bore. In particular, the laser treatment modifies the physical structure of the ferrule to aid in securing the optical fiber within the ferrule bore.

In one embodiment, a ferrule is provided. The ferrule comprising: a ferrule body having a front end, a rear end, and a ferrule bore extending between the front end and the rear end; wherein at least a portion of the ferrule bore comprises a micro-bore; wherein the ferrule body defines an inner surface of the micro-bore; wherein the micro-bore comprises at least one protrusion extending from the inner surface of the ferrule bore and towards a longitudinal axis of the ferrule bore.

In another embodiment, the at least one protrusion has a height ranging between 1 micron and 5000 microns relative to the inner surface of the micro-bore. In another embodiment, the at least one protrusion comprises a plurality of protrusions spaced apart from each other by 90 degrees along the inner surface. In another embodiment, the at least one protrusion comprises a plurality of protrusions that spans a circumference of the inner surface. In another embodiment, the at least one protrusion comprises a plurality of protrusions arranged in a helical pattern along a length of the micro-bore. In another embodiment, a ferrule assembly is provided, wherein the ferrule assembly further comprises: optical fiber inserted into the micro-bore, wherein the at least one protrusion engages with the optical fiber such that the optical fiber is held in place within the ferrule bore.

In one embodiment, a ferrule assembly is provided. The ferrule assembly, further comprising: a ferrule having a front end, a rear end, and a ferrule bore extending between the front end and the rear end, wherein: at least a portion of the ferrule bore comprises a micro-bore, and the micro-bore comprises at least one protrusion extending from an inner surface of the ferrule bore and towards a longitudinal axis of the ferrule bore; and an optical fiber inserted into the micro-bore to define an annular gap between an outer surface of the optical fiber and the inner surface of the micro-bore, the annular gap having a volume; wherein the at least one protrusion occupies a portion of the volume of the annular gap and contacts the optical fiber.

In another embodiment, the at least one protrusion applies a compressive force onto the optical fiber such that the optical fiber has a pull force of at least 2 pounds-force (lbf) as measured by IEC61753.

In one embodiment, a method of terminating an optical fiber with a ferrule, wherein the ferrule having a front end, a rear end, and a ferrule bore extending between the front end and the rear end, wherein at least a portion of the ferrule bore defines a micro-bore is provided. The method comprising: inserting the optical fiber into the micro-bore; and applying a laser treatment onto the ferrule to create at least one protrusion along an inner surface of the micro-bore wherein the at least one protrusion extends towards a longitudinal axis of the micro-bore.

In another embodiment, an annular gap is defined upon insertion of the optical fiber into the micro-bore, the annular gap is between the inner surface of the micro-bore and the outer surface of the optical fiber; wherein the at least one protrusion occupies a portion of the volume of the annular gap and contacts the optical fiber. In another embodiment, the at least one protrusion comprises a plurality of protrusions that spans a circumference of the inner surface. In another embodiment, the at least one protrusion comprises a plurality of protrusions arranged in a helical pattern along a length of the ferrule bore. In another embodiment, the at least one protrusion has a height relative to the inner surface of the micro-bore ranging between 1 micron and 5000 microns. In another embodiment, the method, further comprising: heating the ferrule such that the micro-bore expands prior to inserting the optical fiber; and cooling the ferrule such that the micro-bore contracts onto the optical fiber. In another embodiment, the laser treatment comprises: irraditating one or more locations on the inner surface of the ferrule bore with a laser beam having a wavelength ranging between 0.3 nm and 20 nm. In another embodiment, the laser beam has a pulse width between 10 femtoseconds and 100 milliseconds, a repetition rate between 0 kHz and 200 kHz, and a power output of up to 100 W. In another embodiment, the laser beam is applied onto the inner surface of the micro-bore in a non-orthogonal direction relative to the longitudinal axis of the micro-bore. In another embodiment, the laser beam is applied onto the inner surface of the micro-bore in a direction orthogonal to the longitudinal axis of the micro-bore. In another embodiment, the optical fiber has a pull force of at least 2 pounds-force (lbf) as measured by IEC61753.

In one embodiment, a method of terminating an optical fiber with a fiber optic connector that includes a ferrule having a micro-bore and an end face with a mating location is provided. The method comprising: inserting the optical fiber into the micro-bore of the ferrule; orienting the ferrule and the optical fiber relative to each other to minimize distance between the inner core of the optical fiber and the mating location of the ferrule; applying a laser treatment onto the ferrule to further minimize the distance between the inner core of the optical fiber and the mating location of the ferrule; heating the ferrule a processing temperature above room temperature; and with the ferrule at the processing temperature and with the distance between the inner core and the mating location minimized, coupling the optical fiber to the micro-bore of the ferrule.

In another embodiment, the applying a laser treatment step occurs after the optical fiber is coupled to the micro-bore of the ferrule. In another embodiment, orienting the ferrule and the optical fiber relative to each other further comprises: fixing the orientation of the optical fiber; and rotating the ferrule about a longitudinal axis of the ferrule. In another embodiment, orienting the ferrule and the optical fiber relative to each other comprises: fixing the orientation of the ferrule; and rotating the optical fiber about a longitudinal axis of the optical fiber. In another embodiment, orienting the ferrule and the optical fiber relative to each other comprises rotating the ferrule and the optical fiber about respective central axes of the ferrule and the optical fiber. In another embodiment, the method, further comprising: determining a bore bearing angle of a bore offset of the micro-bore in the ferrule at the end face relative to a reference axis; determining a core bearing angle of a core offset of an inner core in the optical fiber at an end of the optical fiber relative to the reference axis; wherein orienting the ferrule and the optical fiber relative to each other to minimize the distance between the inner core and the mating location comprises orienting the ferrule and the optical fiber relative to each other so that the bore bearing angle of the bore offset and the core bearing angle of the core offset are 180 degrees apart. In another embodiment, the applying the laser treatment step comprises altering an inner surface of the micro-bore such that the bore bearing angle of the bore offset and the core bearing angle of the core offset are 180 degrees apart and a magnitude of the bore offset and a magnitude of the core offset are minimized relative to each other. In another embodiment, the altering step comprises changing the micro-bore from a first shape to a second shape, wherein the first shape has a substantially circular cross section and the second shape has a substantially oval cross section.

Additional features and advantages are set forth in the Detailed Description that follows, and in part will be readily apparent to those skilled in the art from the description or recognized by practicing the embodiments as described in the written description and claims hereof, as well as the appended drawings. It is to be understood that both the foregoing general description and the following Detailed Description are merely exemplary, and are intended to provide an overview or framework to understand the nature and character of the claims.

### BRIEF DESCRIPTION OF THE DRAWINGS

The accompanying drawings are included to provide a further understanding, and are incorporated in and constitute a part of this specification. The drawings illustrate one or more embodiment(s), and together with the Detailed Description serve to explain principles and operation of the various embodiments. As such, the disclosure will become more fully understood from the following Detailed Description, taken in conjunction with the accompanying Figures, in which:

FIG. 1 is a perspective view of an exemplary fiber optic connector;

FIG. 2 is an exploded perspective view of the fiber optic connector shown in FIG. 1;

FIG. 2A is a top view of a ferrule assembly of the exemplary fiber optic connector of FIG. 1 having an optical fiber inserted within a ferrule bore of the ferrule;

FIG. 3A is a top view of a ferrule assembly having an optical fiber inserted within a ferrule bore of a ferrule, where the ferrule has been laser treated to secure the optical fiber in accordance with the present disclosure;

FIG. 3B is a cross-sectional side view of the ferrule assembly of FIG. 3A in accordance with the present disclosure;

FIG. 4A is a top view of an alternate embodiment of the ferrule assembly where the ferrule has been laser treated into an alternate configuration to secure the optical fiber in accordance with the present disclosure;

FIG. 4B is a cross-sectional side view of the ferrule assembly of FIG. 4A in accordance with the present disclosure;

FIG. 5A is a top view of an alternate embodiment of the ferrule assembly where the ferrule has been laser treated (as shown) into an alternate configuration to secure the optical fiber in accordance with the present disclosure;

FIG. 5B is a cross-sectional side view of the ferrule assembly of FIG. 5A in accordance with the present disclosure;

FIG. 6A is a top view of an alternate embodiment of the ferrule assembly where the ferrule has been laser treated into an alternate configuration to secure the optical fiber in accordance with the present disclosure;

FIG. 6B is a cross-sectional side view of the ferrule assembly of FIG. 6A in accordance with the present disclosure;

FIG. 7 is a schematic representation of a laser apparatus that is used in accordance with the present disclosure;

FIG. 8 is a graphical representation of a ferrule that has been laser treated by the laser apparatus of FIG. 7 in accordance with the present disclosure;

FIG. 9 is a schematic illustration of a typical end face of a ferrule of a fiber optic connector having an optical fiber positioned in a micro-bore of the ferrule;

FIG. 9A is an enlarged schematic illustration of the area 9A shown in FIG. 9;

FIG. 10 is a schematic illustration of an end face of a ferrule of fiber optic connector showing a bore offset;

FIG. 11 is a schematic illustration of an end of an optical fiber showing a core offset;

FIG. 12 is a schematic illustration of the end of the fiber optic connector with the optical fiber positioned in the micro-bore of the ferrule;

FIG. 13 is a schematic illustration of the fiber optic connector of FIG. 12 with the core-to-ferrule offset minimized by rotating the optical fiber;

FIG. 14 relates to Example 1 and provides a graphical representation of an improved breaking force requirement of an optical fiber within a ferrule assembly of the present disclosure; and

FIG. 15 relates to Example 2 and illustrates a maximum breaking force of an optical fiber within a ferrule assembly of the present disclosure.

### DETAILED DESCRIPTION

Reference is now made in detail to various embodiments of the disclosure, examples of which are illustrated in the accompanying drawings. Whenever possible, the same or like reference numbers and symbols are used throughout the drawings to refer to the same or like parts. The drawings are not necessarily to scale, and one skilled in the art will recognize where the drawings have been simplified to illustrate the key aspects of the disclosure.

The claims as set forth below are incorporated into and constitute part of this Detailed Description.

Cartesian coordinates are shown in some of the Figures for the sake of reference and are not intended to be limiting as to direction or orientation.

In the discussion below, the term “cylindrical” is not limited to body having a strictly circular cross-sectional shape and can include other cross-sectional shapes.

Also in the discussion below, the term “core-ferrule concentricity” can also be referred to as the “coaxiality,” and the concentricity error can be referred to as a “coaxial error” or the “coaxiality error.”

And in this disclosure, any ranges of values includes the stated end points of the range. For example, a range that is stated as being between A and B, or from A to B, with A and B being numerical values, includes both A and B in the stated range.

In general, the present disclosure relates to laser treatment of a ferrule to secure an optical fiber within a ferrule bore. In particular, the laser treatment modifies the physical structure of the ferrule to aid in securing the optical fiber within the ferrule bore.

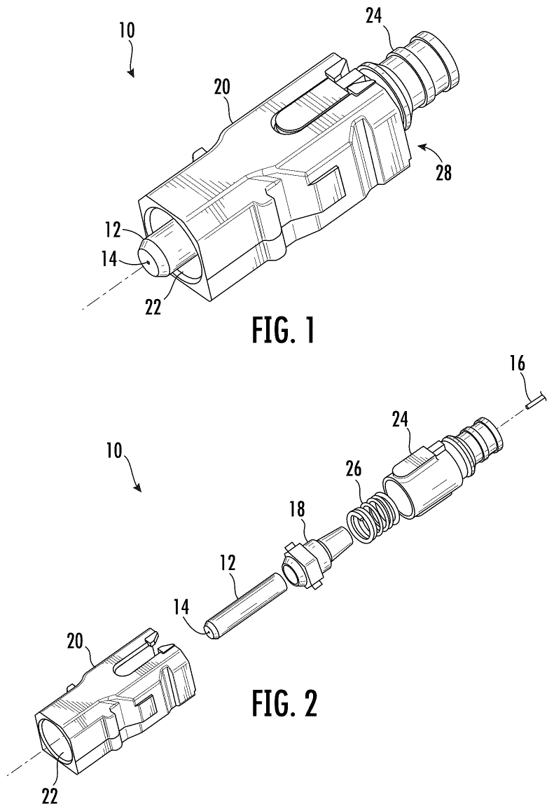

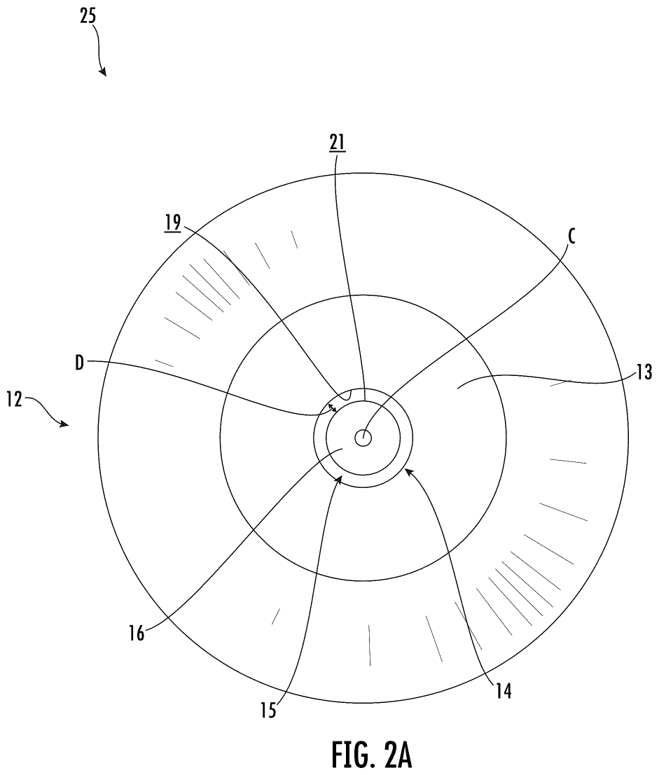

Referring first to FIGS. 1 and 2, an exemplary fiber optic connector 10 used in many modern fiber optic networks is shown. Although the fiber optic connector 10 is shown in the form of a SC-type connector, the features may be applicable to different connector designs. This includes ST, LC, and MU-type connectors, for example, and other single-fiber or multi-fiber connector designs. As shown in these figures, the connector 10 includes a ferrule 12 having a ferrule bore 14 (“micro-bore”) configured to support an optical fiber 16, a ferrule holder 18 from which the ferrule 12 extends, a housing 20 having a cavity 22 in which the ferrule 12 and ferrule holder 18 are received, and a connector body 24 configured to cooperate with the housing 20 to retain the ferrule 12 and ferrule holder 18 within the housing 20. More specifically, a back end of the ferrule 12 is received in a first portion of the ferrule holder 18 and is secured therein in a known manner (e.g., press-fit, adhesive, molding the ferrule holder 18 over the back end of the ferrule 12, etc.). The ferrule 12 and ferrule holder 18 may even be a monolithic structure in some embodiments. The ferrule holder 18 is biased to a forward position within the housing 20 by a spring 26, which extends over a second portion of the ferrule holder 18 that has a reduced cross-sectional diameter/width compared to the first portion. The spring 26 also interacts with internal geometry of the connector body 24, which may be secured to the housing 20 using a snap-fit or the like. For example, FIGS. 1 and 2 illustrate a rear portion of the housing 20 having cut-outs or slots on opposite sides so as to define a split shroud. The connector body 24 has tabs configured to be snapped into the slots and retained therein due to the geometries of the components.

When the connector 10 is assembled as shown in FIG. 1, a front end of the ferrule 12 projects beyond a front end of the housing 20. The ferrule end face presents the optical fiber 16 for optical coupling with a mating component (e.g., another fiber optic connector; not shown), such as an adapter. Thus, when the fiber optic connector 10 is mated with the other component, the optical fiber(s) 16 in the ferrule 12 can be held in alignment with the optical fiber(s) 16 of the mating ferrule 12 to establish an optical connection.

While optical fiber(s) 16 of mated ferrules are held in alignment for the purposes of establishing an optical connection, optical fiber(s) are also held in place within ferrule 12 for alignment within connector 10 itself. In particular, optical fiber(s) 16 interact with micro-bore 14 of ferrule 12 such that optical fiber(s) 16 are secured within ferrule 12, and as discussed in greater detail herein, ferrule 12 is laser treated such that the surface properties of micro-bore 14 is altered, whereby micro-bore 14 contacts optical fiber(s) 16 to lock optical fiber(s) 16 within ferrule 12.

Ferrule Assembly 25

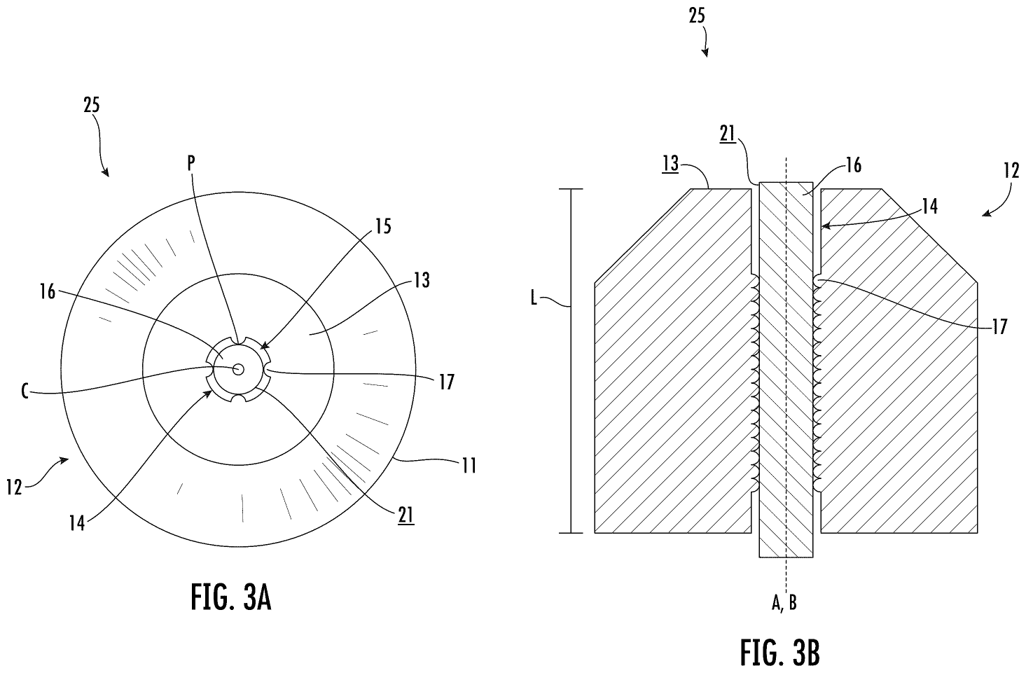

Referring now to FIGS. 3A-6B, detailed views of ferrule assemblies 25 are shown. Ferrule assemblies 25 comprise a ferrule 12 with optical fiber 16 inserted into micro-bore 14 along longitudinal axis B of micro-bore 14. With regards to FIGS. 3A-6B, ferrule assemblies 25 are shown after laser treatment, the conditions of which are discussed in greater detail below.

Referring briefly to FIG. 2A, a standard ferrule assembly 25 is shown where ferrule 12 has optical fiber 16 inserted into micro-bore 14. As shown, optical fiber 16 is positioned within micro-bore 14 of ferrule 12 such that an annular gap 15 exists between an inner surface 19 of micro-bore 14 and an outer surface 21 of optical fiber 16. In some embodiments, annular gap 15 spans a distance D of about 300 nm from outer surface 21 of optical fiber 16 and inner surface 19 of micro-bore 14. By comparison, ferrules 12 as shown in FIGS. 3A-6B have a reduced annular gap 15 due to the change in surface properties by laser treatment as discussed in greater detail below.

Referring back to FIGS. 3A and 3B, ferrule assembly 25 is shown where protrusions 17 extend from inner surface 19 of micro-bore 14. In particular, protrusions 17 extend inwardly toward longitudinal axis B of micro-bore 14 and contact outer surface 21 of optical fiber 16 such that compressive forces are applied onto optical fiber 16 thereby locking optical fiber 16 in place within micro-bore 14. In particular, in this embodiment, there are four protrusions 17 each about 90 degrees apart relative to each other that extend along at least a portion of length L of micro-bore 14. The angular orientation of protrusions 17 provide compressive forces in opposite directions to hold optical fiber 16 in place. Protrusions 17 have a height ranging between 1 nanometers (nm) and 5000 nm or between 10 nm and 5000 nm. As used herein, “height” of protrusion 17 refers to the distance from inner surface 19 of micro-bore 14 to an apex P of protrusion 17. In some embodiments, protrusions 17 occupy a portion of the volume of annular gap 15 within micro-bore 14 and contact outer surface 21 of optical fiber 16. In this embodiment, all of the protrusions 17 have substantially the same height. However, in alternate embodiments and as discussed herein, heights of the protrusions 17 may vary.

Referring to FIG. 3B, protrusions 17 are within micro-bore 14 and are not flush with end face 13 of ferrule 13. That is, protrusions 17 are positioned within micro-bore 14 between end face 13 of ferrule 12 and a rear end of micro-bore 14. Stated another way, protrusions 17 are present along a portion of length L of micro-bore 14. It is within the scope of the present disclosure that in alternate embodiments, protrusions 17 are present along the entire length L of micro-bore 14.

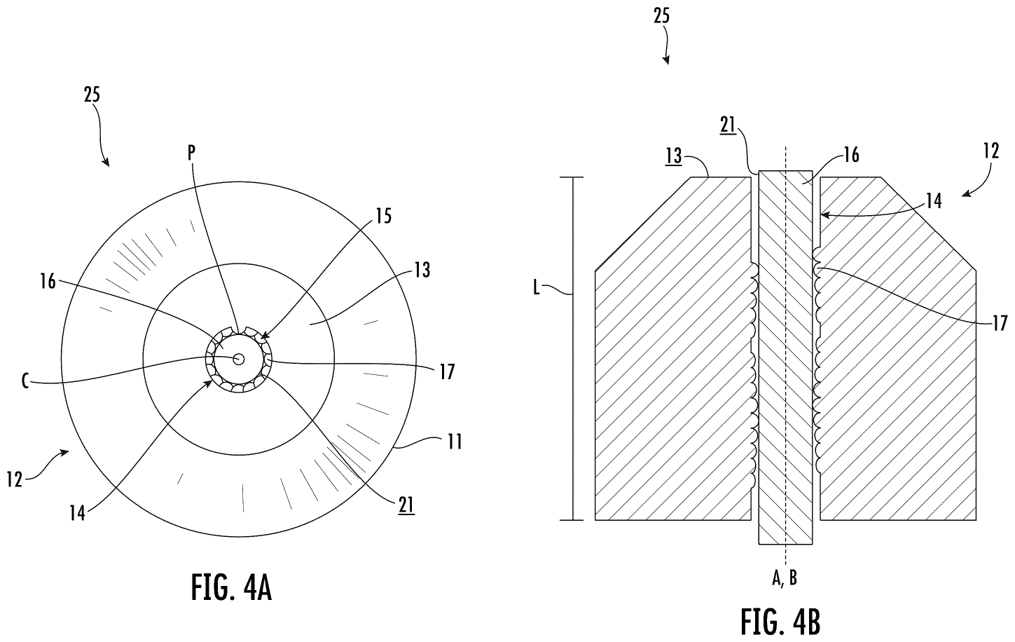

Referring now to FIGS. 4A and 4B, ferrule assembly 25, ferrule 12, protrusions 17, and optical fiber 16 are substantially the same as those referenced in FIGS. 3A and 3B except as noted below. FIGS. 4A and 4B show protrusions 17 in a spiral or helical pattern within micro-bore 14. An advantage of such a configuration is that the forces applied onto outer surface 21 of optical fiber 16 is distributed about the circumference of optical fiber 16 rather than specific points on outer surface 21 of optical fiber 16.

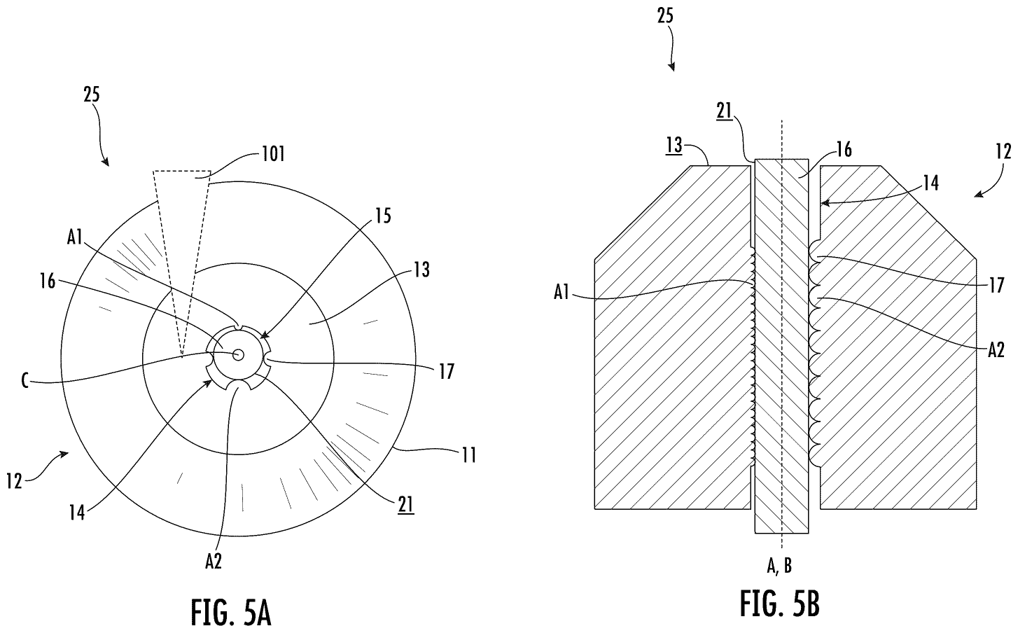

Referring now to FIGS. 5A and 5B, ferrule assembly 25, ferrule 12, protrusions 17, and optical fiber 16 are substantially the same as those referenced in FIGS. 3A and 3B except as noted below. FIGS. 5A and 5B show protrusions 17 in a similar pattern as shown in FIGS. 3A and 3B. However, protrusions 17 vary in height about the circumference micro-bore 17. In some embodiments, protrusion 17 near reference point A1 of micro-bore 14 has a height ranging between 1 nm and 5000 nm or between 10 nm and 5000 nm. In some embodiments, protrusion 17 near reference point A2 of micro-bore 14 has a height ranging between 1 nm and 5000 nm or between 10 nm and 5000 nm. The remaining protrusions 17 have a height within the ranges outlined above with respect to FIGS. 3A and 3B.

The variation in protrusion height among protrusions 17 vary the magnitudes of the forces applied onto optical fiber 16. That is, larger protrusions provide larger magnitudes of force onto optical fiber 16. For example, the protrusion 17 near reference point A2 applies a larger force than the opposite protrusion 17 near reference point A1 resulting in optical fiber 16 being positioned closer to reference point A1.

The variation in protrusion height also varies the size of annular gap 15 about the circumference of micro-bore 14. In particular, as shown in FIG. 5A, the size of annular gap 15 near reference point A1 is less than the size of annular gap 15 near reference point A2 that is diametrically opposed to A1. Such configurations can provide advantageous alignment configurations to offset eccentricities, such as core to ferrule eccentricity as discussed in greater detail below. Stated another way, by varying the height of protrusions 17, optical fiber 16 can be shifted within micro-bore 14 such that optical fiber 16 can be in better alignment within the ferrule, i.e., offsetting or minimizing any core to ferrule eccentricity that may be present.

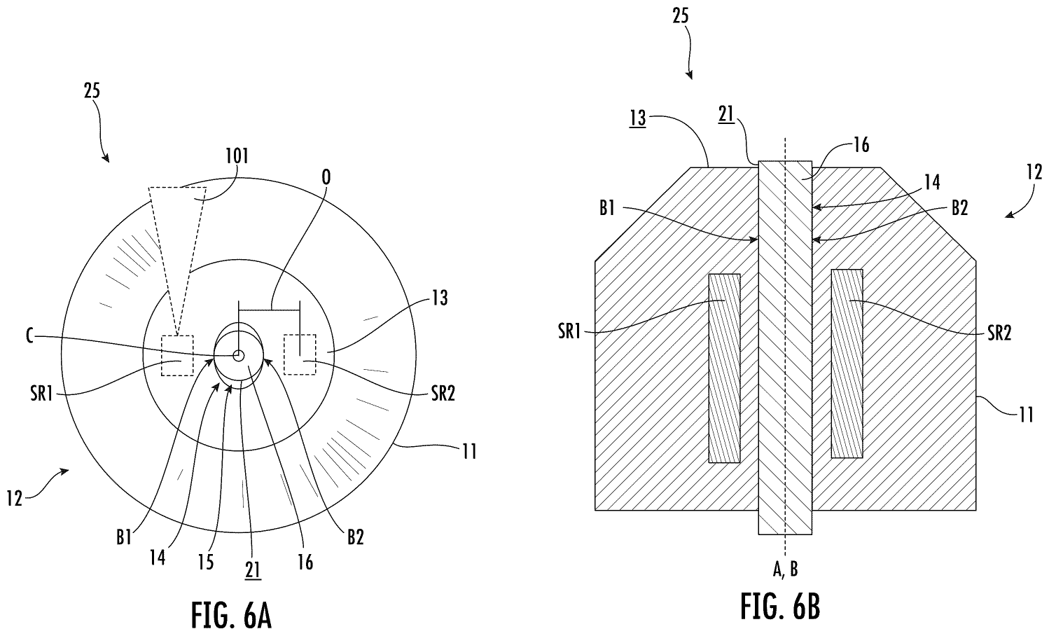

Referring now to FIGS. 6A and 6B, a ferrule assembly 25 is shown with a ferrule 12 having an optical fiber 16 inserted within micro-bore 14 where ferrule 12 includes stress regions SR1 and SR2 within ferrule body 11 of ferrule 12. Stress regions SR1 and SR2 are designated areas within ferrule body 11 that receive laser treatment as discussed in greater detail herein. When stress regions SR1 and SR2 receive the laser treatment, stress regions SR1, SR2 swell such that the shape of micro-bore 14 changes. For example, as shown in FIG. 6A, upon laser treatment, micro-bore 14 transitions from a substantially circular cross section to a substantially oval cross section in which inner surface 19 of micro-bore 14 contacts outer surface 21 of optical fiber 16 as shown at regions B1 and B2. It is within the scope of the present disclosure that alternate cross sectional shapes of micro-bore 14 can result after laser treatment of stress regions SR1, SR2. As also shown in FIGS. 6A and 6B, laser beam 101 contacts end face 13 of ferrule 12 at stress regions SR1, SR2, which are at an offset distance O (hereinafter referred to as “offset O”) from center C of micro-bore 14. In some embodiments, offset O ranges between 60 microns and 500 microns, between 62 microns and 500 microns, or between 62.5 microns and 500 microns as measured from center C of micro-bore 14.

Also, similar to the discussion above with respect to FIGS. 5A and 5B, such an alteration of the size of micro-bore 14 can provide advantageous alignment configurations to offset eccentricities, such as core to ferrule eccentricity as discussed in greater detail below.

An advantage of either protrusions 17 or altering the shape of micro-bore 14 (FIGS. 6A and 6B) is that micro-bore 14 can directly lock optical fiber 16 into place within micro-bore 14 and ferrule assembly 25 without the use of an adhesive or adhesive material (e.g., a bonding agent). This provides cost savings as fewer materials are needed to assemble connector 10 (i.e., no bonding agent). This also reduces the number of assembly steps as insertion or injection of an adhesive is no longer needed.

Optical Fiber 16

The methods described herein can be used with different types of optical fibers. Optical fiber(s) 16 includes a core and a cladding surrounding the core. In some embodiments, optical fiber 16 includes an inner cladding surrounding the core where the inner cladding is surrounded by the cladding mentioned above (i.e., an outer cladding). The core and cladding are composed of materials with an appropriate refractive index differential to provide desired optical characteristics. In some embodiments, the cladding includes all glass portions (e.g., silica glass) of an optical fiber 16 outside the core and is not limited to glass portions of optical fiber 16 outside of the core which are optically functional.

In some embodiments, the cladding (or outer cladding) is a titania-doped cladding to provide improved surface characteristics to optical fiber 16. Examples of optical fibers with such a construction are disclosed in U.S. Pat. No. 5,318,613, the disclosure of which is hereby incorporated by reference. For example, in one embodiment, the cladding (or outer cladding) comprises silica doped with titania (TiO₂-SiO₂) with varying titania concentrations. In some embodiments, the cladding (or outer cladding) has a titania concentration between 4 wt. % and 20 wt. %, between 4 wt. % and 16 wt. %, between 6 wt. % and 14 wt. %, or between 8 wt. % and 12 wt. % based on the total weight of the cladding (or the outer cladding). The cladding (or outer cladding) may have a thickness between 1 micron and 20 microns, between 2 microns and 15 microns, or between 2 microns and 10 microns. In some embodiments, optical fiber 16 may be a bend insensitive fiber.

Laser Apparatus 100 and Method of Assembling Ferrule Assembly 25

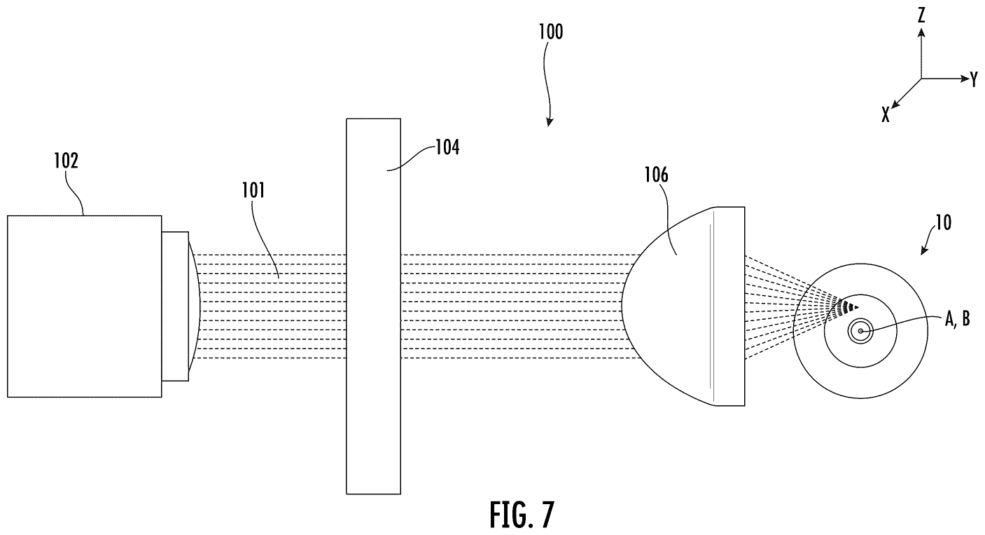

Referring now to FIG. 7, a laser apparatus 100 is shown. Laser apparatus 100 is configured to change the surface properties of ferrule 12 by laser treatment. In particular, as discussed in greater detail herein, laser apparatus 100 applies a laser beam 101 onto ferrule 12 to change the surface properties of micro-bore 14 (i.e., protrusions 17 or altering the shape of micro-bore 14) such that micro-bore 14 directly engages with optical fiber(s) 16 within ferrule 12.

Laser apparatus 100 includes a laser 102 and a pair of lenses 104, 106. As shown in FIG. 7, laser 102 emits a laser beam(s) 101 in the y-direction of the Cartesian coordinate system as defined in the Figure. In this configuration, laser 102 and laser apparatus 100 are oriented perpendicular to a longitudinal axis B of micro-bore 14 of ferrule 12. In an alternate embodiment, laser 102 emits laser beam(s) 101 in a direction that is in line with a longitudinal axis A, B of optical fiber 16 and ferrule 12, respectively. In an alternate embodiment, laser 102 and laser apparatus 100 are oriented at an angle relative to a longitudinal axis A, B of optical fiber 16 and ferrule 12, respectively. In some embodiments, laser 102 is a CO (carbon monoxide) laser. However, it is contemplated that in alternate embodiments, a different suitable type of laser may be used, such as continuous wave (CW), quasi-continuous wave lasers (QCW), quantum cascade lasers (QCL), carbon dioxide (CO2) lasers, pulsed nanosecond laser, or the like, for example.

Laser beam(s) 101 are configured to irradiate ferrule 12 such that the surface properties of micro-bore 14 change such that micro-bore 14 engages with an outer surface 21 of optical fiber 16. Stated another way, laser beam(s) 101 are applied onto ferrule 12 such that a phase transformation occurs within ferrule 12 (i.e., from tetragonal zirconia to monoclinic zirconia). In particular, laser beam(s) 101 are applied onto an end face 13 of ferrule 12 such that bulk modification of ferrule 12 occurs in the form of localized heating on ferrule 12 where melting and volumetric expansion of ferrule 12 occurs. Subsequent cooling of ferrule 12 can produce microcracks and dislocation of grains of ferrule 12 resulting in the previously mentioned phase transformation which is accompanied by density decrease and volume expansion within micro-bore 14 of ferrule 12. When the bulk modification of ferrule 12 via laser beam(s) 101 occurs close to micro-bore 14, the compression decreases the size of micro-bore 14 thereby engaging micro-bore 14 with an outer surface of optical fiber 16. Stated another way, when the bulk modification of ferrule 12 occurs close to micro-bore 14, the compression can yield protrusions 17 or can change the shape of micro-bore 14 as discussed above.

In some embodiments, laser 102 emits laser beam(s) 101 at a wavelength in the range of microns 20 microns, 2 microns to 10 microns, or 2 microns to 6 microns. In some embodiments, laser beam 102 has a wavelength of about 3 microns. In some embodiments, laser beam(s) 102 are emitted as laser pulses with a pulse. In some embodiments, laser beam(s) 102 has a pulse width ranging between 10 femtoseconds to 100 milliseconds, 1 microsecond and 1 second, or between 100 microseconds and 100 milliseconds. In some embodiments, a laser beam 102 has a frequency ranging between 10 Hz and 1 MHz, between 100 Hz and 100 kHz, or between 100 Hz and 50 kHz.

In some embodiments, laser 102 emits laser beam 101 at a repetition rate ranging between 0 kilohertz (kHz) and 200 kHz. In some embodiments, laser 102 emits laser beam 101 at an output power of up to about 100 Watts (W). In some embodiments, laser beam 101 has a pulse energy ranging between 10 μJ and 10,000 μJ.

As mentioned previously, laser beam 101 passes through a pair of lenses 104, 106 en route to ferrule 12 and optical fiber(s) 16. In particular, laser beam(s) 101 pass through an aspherical lens 104 and a focusing lens 106. Aspherical lens 104 is configured to redirect laser beam(s) 101 towards focusing lens 106 and ferrule 12. After passing through aspherical lens 104, laser beam(s) 101 pass through focusing lens 106 and onto ferrule 12. In some embodiments, focusing lens 104 directs laser beam(s) 101 such that laser beam(s) 101 contact ferrule 12 at a focus of focusing lens 104. However, it is within the scope of the present disclosure that in some embodiments, focusing lens 104 directs laser beam(s) 101 such that laser beam(s) 101 contact ferrule 12 outside of a focus of focusing lens 104. In some embodiments, focusing lens 104 has a focal length ranging between 1 mm and 25 mm, between 2.5 mm and 20 mm, or between 5 mm and 10 mm.

In some embodiments, a laser beam 101 can be used in conjunction with a spatial light modulator (SLM). The spatial light modulator modulates intensity, phase or both to mitigate scattering effects of laser beam 101 during laser beam propagation in ferrule 12. Moreover, the use of an SLM enables laser bulk modification of ferrule 12 using a laser 102 emitting a laser beam 101 with a wavelength shorter than 2 microns, where scattering of laser beam is significant.

As mentioned previously and with brief reference to FIGS. 6A and 6B, laser beam 101 contacts end face 13 of ferrule 12. In some embodiments, laser beam 101 contacts end face 13 at an offset distance O (hereinafter referred to as “offset O”) from center C of micro-bore 14. In some embodiments, offset O ranges between 60 microns and 500 microns, between 62 microns and 500 microns, or between 62.5 microns and 500 microns as measured from center C of micro-bore 14. In some embodiments, offset O may be uniform about micro-bore 14 (e.g., a concentric circle around micro-bore 14 having offset O as the radius). However, in alternate embodiments, offset O may be asymmetric about micro-bore 14 (e.g., an elliptical shape about micro-bore 14). In another alternate embodiment, laser beam 101 may contact end face 13 at discrete points along end face 13 where the respective offset O distances relative to center C are equal. However, in alternate embodiments, laser beam 101 may contact end face 13 at discrete points along end face 13 where the respective offset O distances vary. While the above paragraph is in reference to FIGS. 6A and 6B, the offset O disclosure discussed herein is applicable to other embodiments disclosed herein too.

To operate laser apparatus 100, a connector 10 with optical fiber 16 and ferrule 12 is placed within laser apparatus 100 (e.g., within a V-groove or a stage to hold connector 10 in place). Ferrule 12 is pre-heated to expand micro-bore 14 of ferrule 12 such that optical fiber 16 can be inserted into micro-bore 14 of ferrule 12. Then, ferrule 12 is cooled (e.g., heat is removed), whereby ferrule 12 and micro-bore 14 contract and substantially return to their original shape prior to heating. While ferrule 12 is cooling, laser beam(s) 101 is emitted from laser 102 and travels through apparatus 100 as shown in FIG. 7 (i.e., passing through aspheric lens 104 and focusing lens 106) such that laser beam(s) 101 contact ferrule end face 103 to change the bulk surface properties of micro-bore 14 and reduce the size of micro-bore 14 as discussed above.

In another embodiment, to operate laser apparatus 100, a connector 10 with optical fiber 16 and ferrule 12 is placed within laser apparatus 100 (e.g., within a V-groove or a stage to hold connector 10 in place). In this embodiment, optical fiber 16 is directly inserted into micro-bore 14 of ferrule 12 without pre-heating ferrule 12. Then, after insertion of optical fiber 16, laser 102 is activated to emit laser beam(s) 101. Laser beam(s) 101 is emitted from laser 102 and travels through apparatus 100 as shown in FIG. 3 (i.e., passing through aspheric lens 104 and focusing lens 106) such that laser beam(s) 101 contact ferrule end face 103 to change the bulk surface properties of micro-bore 14 and reduce the size of micro-bore 14 as discussed above.

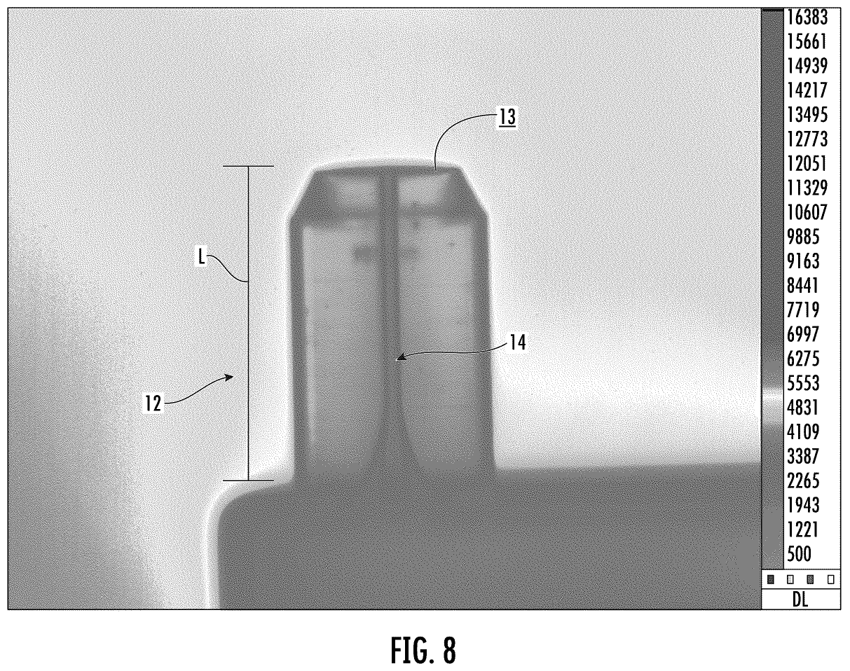

Referring now to FIG. 8, a ferrule 12 after laser treatment is shown. As mentioned previously, laser treating ferrule 12 in accordance with the present disclosure can change the surface bulk properties of ferrule 12. As shown, when ferrule 12 is subjected to laser treatment, portions of micro-bore 14 within micro-bore 14 received greater radiation from laser 102 than portions of micro-bore 14 closer to end face 13. Stated another way, greater irraditation of ferrule 12 occurred within ferrule 12 to change the bulk surface properties of micro-bore 14. In some embodiments, changes to the bulk surface properties of micro-bore 14 occurred about 1.1 millimeters (mm) below end face 13.

Properties of Ferrule Assembly 25

As discussed above, protrusions 17 or the change in shape of micro-bore 14 (FIGS. 6A and 6B) enable ferrule 12 to directly lock optical fiber 16 into place within micro-bore 14 and form ferrule assembly 25. Ferrule assembly 25 has certain properties described below.

In some embodiments, ferrule assembly 25 when installed into connector 10 has an insertion loss of less than 0.25 decibels (dB), less than 0.12 dB, or less than 0.05 dB at reference wavelengths between 1310 nanometers (nm) and 1625 nm as measured by methods known in the art. For example, in one embodiment, the reference wavelength is 1550 nm. In some embodiments, connector 10 has an insertion loss of less than 0.25 decibels (dB), less than 0.12 dB, or less than 0.05 dB at a reference wavelength of 1310 nanometers (nm) as measured by methods known in the art. In some embodiments, connector 10 has an insertion loss of less than 0.25 decibels (dB), less than dB, or less than 0.05 dB at a reference wavelength of 850 nanometers (nm) as measured by methods known in the art.

In some embodiments, optical fiber 16 has a fiber movement within connector 10 of less than 30 nanometers (nm), less than 20 nm, or less than 10 nm as measured by the methods disclosed below.

In some embodiments, optical fiber 16 has a pre-thermal cycling fiber pull force of greater than 2 pounds force (lbf) as measured by the method disclosed in IEC 61753.

Eccentricity Correction

The methods described above provide a direct locking mechanism in which the micro-bore 14 of ferrule 12 can engage and lock optical fiber(s) 16 in place within ferrule 12 of ferrule assembly 25. In addition to locking the optical fiber(s) 16 in place, this mechanism can also be used to improve alignment within the ferrule assembly 25 as discussed in greater detail below.

Various embodiments will be further clarified by examples in the description below. In general, the description relates to a method for improving the alignment of optical fibers across an optical connection by minimizing the offset between the inner core of the optical fiber and a fixed mating location on the ferrule of a fiber optic connector. The mating location is the area or portion of the ferrule end face that receives the end of the optical fiber and is configured to engage, confront or otherwise optically “connect” to an optical fiber in the other optical component (e.g., another fiber optic connector). The position of the mating location may depend on several factors, including the type of fiber optic connector. By minimizing the distance or offset (between the inner core of the optical fiber and a fixed mating location on the ferrule of the fiber optic connector), the position of the fiber core becomes more predictably located at or near the intended mating location of the fiber optic connector. Thus, when two fiber optic connectors are mated together such that the intended mating locations engage or confront each other and each of the fiber optic connectors have had the offset minimized, the insertion losses may be minimized since the respective inner cores of the optical fibers in the connectors are more likely to be aligned or more closely aligned than if the offsets were not minimized. The method in accordance with the present disclosure minimizes the offset between the fiber core and the mating location on the ferrule in a straightforward manner. In this regard, the reduction in insertion losses across an optical connection in accordance with aspects of the present disclosure may be achieved with existing materials, parts, and with minimal changes to current manufacturing techniques. Thus, the resulting reduction in insertion losses across an optical connection may be achieved in a cost-effective manner.

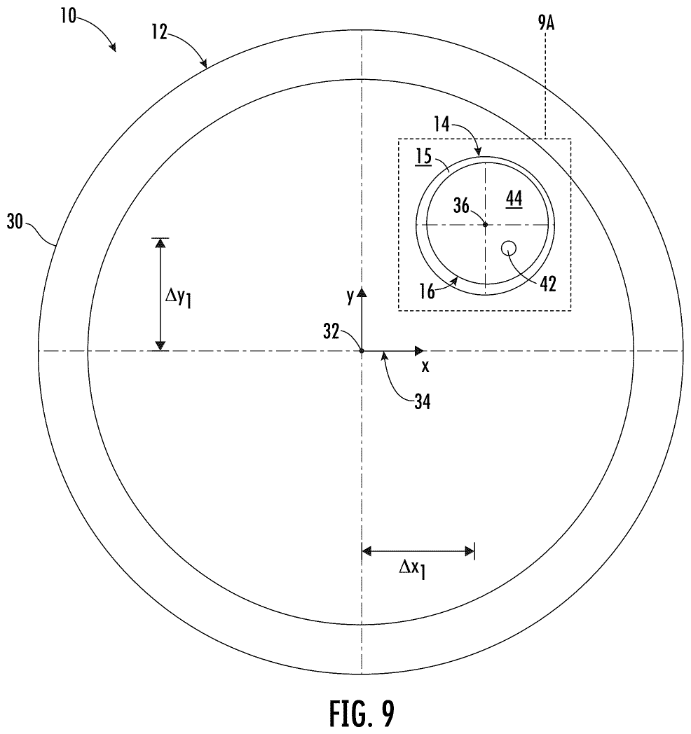

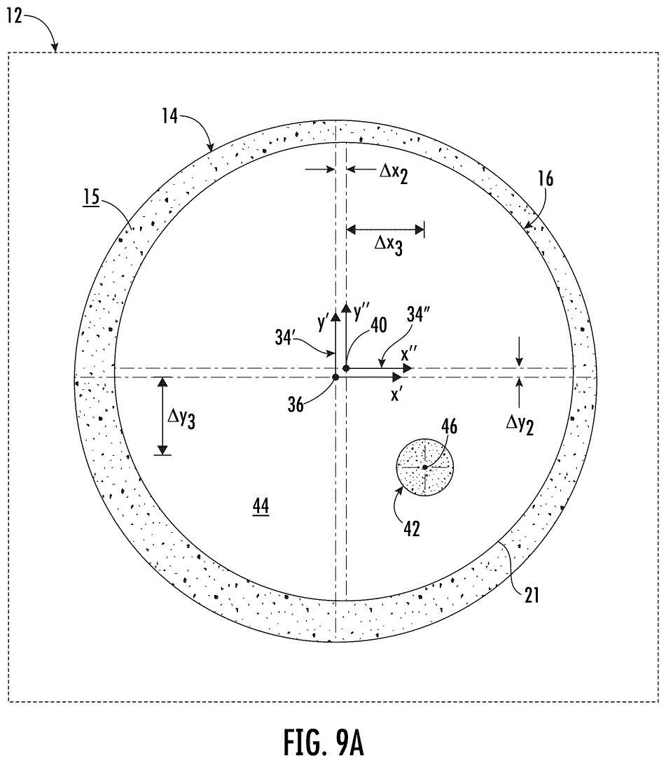

FIGS. 9 and 9A are schematic illustrations of an exemplary geometry at a tip of a fiber optic connector, such as fiber optic connector 10 illustrated in FIG. 1. The ferrule 12 includes an outer surface 30 that defines a center 32 (referred to as ferrule center 32). For purposes of discussion, a coordinate system 34 may be positioned at ferrule center 32 that defines orthogonal axes x and y (e.g., a Cartesian coordinate system). As explained above, the ferrule 12 includes a micro-bore 14 that is configured to receive the bare optical fiber 16. Ideally, the micro-bore 14 would be located such that the center 36 of the micro-bore 14 (referred to as bore center 36) coincides with the ferrule center 32. A coordinate system 34′ may be positioned at bore center 36 that defines orthogonal axes x′ and y′. Due to inherent tolerance variations in the materials and manufacturing processes, however, the micro-bore 14 is typically offset from the ferrule center 32 by some amount Δₓ₁, Δ_{y1}. The optical fiber 16 is configured to be positioned in the micro-bore 14 and secured within the micro-bore 14 using a suitable method as discussed herein. In current manufacturing methods, the micro-bore 14 is oversized relative to the optical fiber 16 such that the center 40 of the optical fiber 16 (referred to as fiber center 40) is typically offset from the bore center 36 by some amount Δₓ₂, Δ_{y2}. Moreover, and as noted above, the optical fiber 16 includes an inner core 42 and an outer cladding 44. Ideally, the inner core 42 would be located such that the center 46 of the inner core 42 (referred to as core center 46) coincides with the fiber center 40. A coordinate system 34″ may be positioned at fiber center 40 that defines orthogonal axes x″ and y″. Due to inherent tolerance variations in the materials and manufacturing processes, however, the core center 46 is typically offset from the fiber center 40 by some amount Δₓ₃, Δ_{y3}.

As demonstrated above, the position of the inner core 42 of the optical fiber 16 relative to the mating location of the ferrule 12 may have a wide range of variance. That variation is influenced at least in part by: i) the position of the micro-bore 14 within the ferrule 12; ii) the position of the optical fiber 16 within the micro-bore 14; and iii) the position of the inner core 42 within the optical fiber 16. The challenge for reducing insertion losses is to locate the core center 46 as close as possible to the mating location on the ferrule 12 given the variations present in current materials and manufacturing techniques. In an exemplary embodiment, the ferrule center 32 may operate as the mating location of the ferrule 12, and the description below is premised on minimizing the offset between the center 46 of the inner core 42 and the center 32 of the ferrule 12. This offset is referred to as the core-to-ferrule offset and indicates the deviation in the position of the inner core 42 from its intended position (i.e., at the mating location). Stated another way, when referring to minimizing the distance/offset between the core and the mating location in the present disclosure, the core referenced is core center 46.

While the description below provides the mating location at the ferrule center 32, it should be recognized that aspects of the present disclosure also apply to embodiments where the mating location is not at the ferrule center 32 but at some other point on the ferrule 12 offset from the center 32. The goal would then be to minimize the offset between the core center 46 and the off-center mating location of the ferrule in that embodiment.

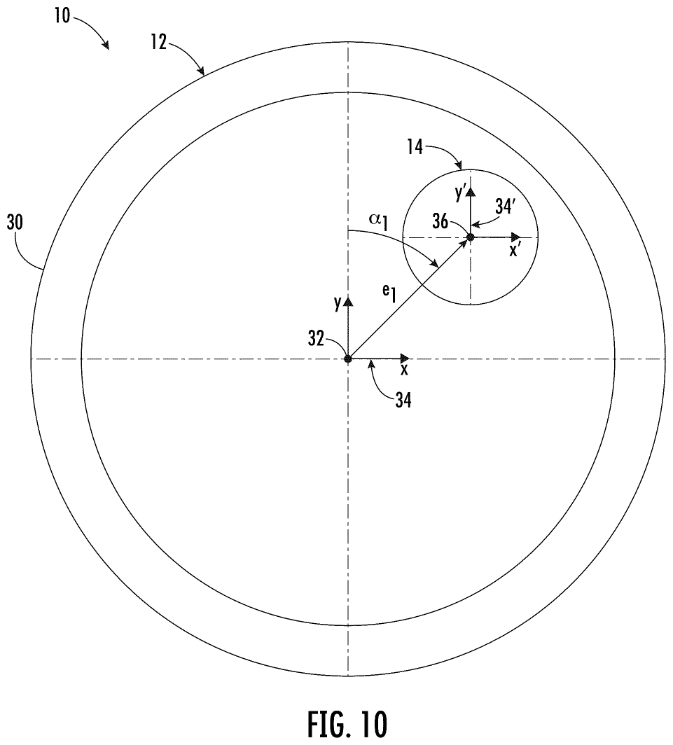

FIGS. 10-13 generally describe a method for minimizing the distance between the center 46 of the inner core 42 and the center 32 of the ferrule 12 (the core-to-ferrule offset) taking into account variations in the micro-bore 14 position within the ferrule 12 and variations in the inner core 42 position within the optical fiber 16 (i.e., numerals i) and iii) listed above). FIG. 10 is a schematic illustration of a ferrule 12 having an off-center micro-bore 14. The ferrule 12 includes an outer surface 30 that defines the center 32 of the ferrule 12. The coordinate system 34 is shown having its origin at the center 32 of the ferrule 12. The position of the center 36 of the micro-bore 14 relative to the center 32 of the ferrule 12 may be characterized by a radial distance e₁ and a reference angle α₁. Thus, the center 36 of the micro-bore 14 may be positioned at (e₁, α₁) in cylindrical coordinates. The value e is referred to as the eccentricity and a is referred to as the bearing angle. The bore eccentricity is relative to the center 32 of the ferrule 12 and the bore bearing angle is relative to a reference axis, which may be the vertical axis (i.e., the positive y axis in FIG. 4). Other reference axes, however, may be possible.

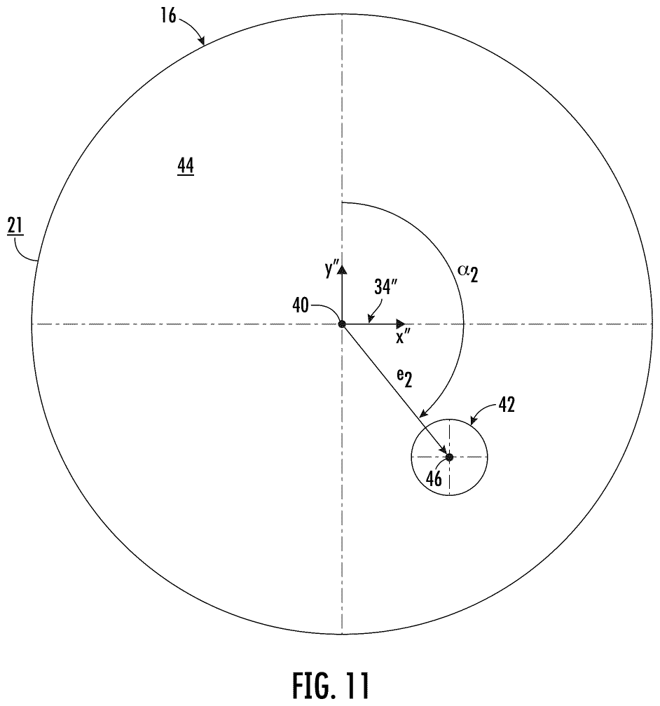

In a similar manner, FIG. 11 is a schematic illustration of an optical fiber 16 having an off-center inner core 42. The optical fiber 16 includes an outer surface 21 that defines the center 40 of the optical fiber 16. The coordinate system 34″ is shown having its origin at the center 40 of the optical fiber 16. The position of the core center 46 of the inner core 42 relative to the fiber center 40 may be characterized by eccentricity e₂ and bearing angle α₂. Thus, the core center 46 of the inner core 42 may be positioned at (e₂, α₂) in cylindrical coordinates. The core eccentricity is relative to the center 40 of the optical fiber 16 and the core bearing angle is relative to a reference axis, which may be the vertical axis (i.e., the positive y″ axis in FIG. 11).

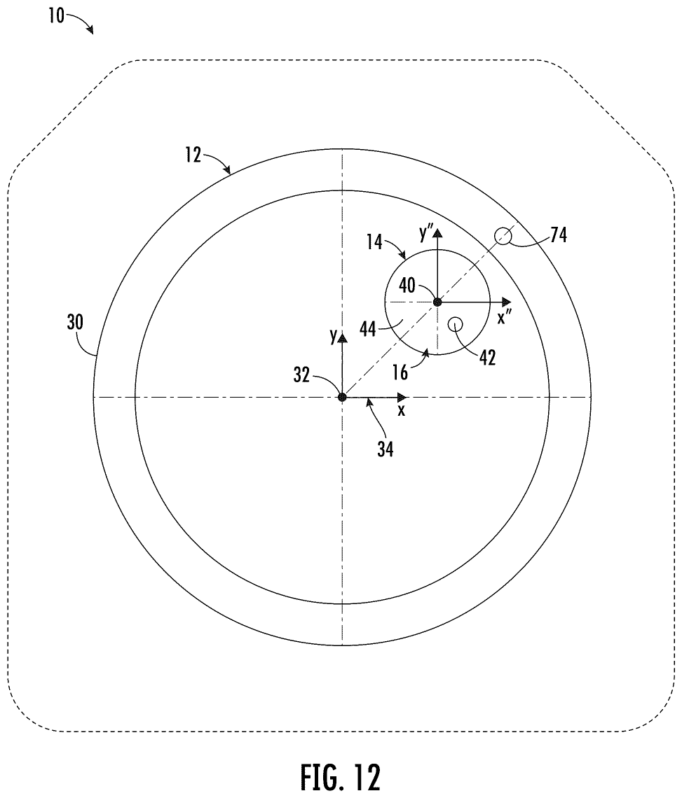

FIG. 12 illustrates the optical fiber 16 positioned within the micro-bore 14 with the ferrule 12 and the optical fiber 16 in the same orientation as provided in FIGS. 10 and 11, respectively, and ignoring any offset due to the position of the optical fiber 16 in the micro-bore 14. While the eccentricities of the micro-bore 14 and the inner core 42 relative to the ferrule center 32 and fiber center 40, respectively, are fixed for a given ferrule 12 and optical fiber 16 pair, the relative orientation of the ferrule 12 and the optical fiber 16 may be manipulated in order to minimize the core-to-ferrule offset. More particularly, if the bearing angles α₁ and α₂ are arranged 180 degrees apart and the inner core 42 is radially inboard of the fiber center 40, then the distance between the core center 46 and the ferrule center 32 will be minimized. This means that given a particular ferrule 12 and optical fiber 16 pair, the inner core 42 can be positioned as close as possible to the intended mating location of the ferrule 12 of fiber optic connector 10.

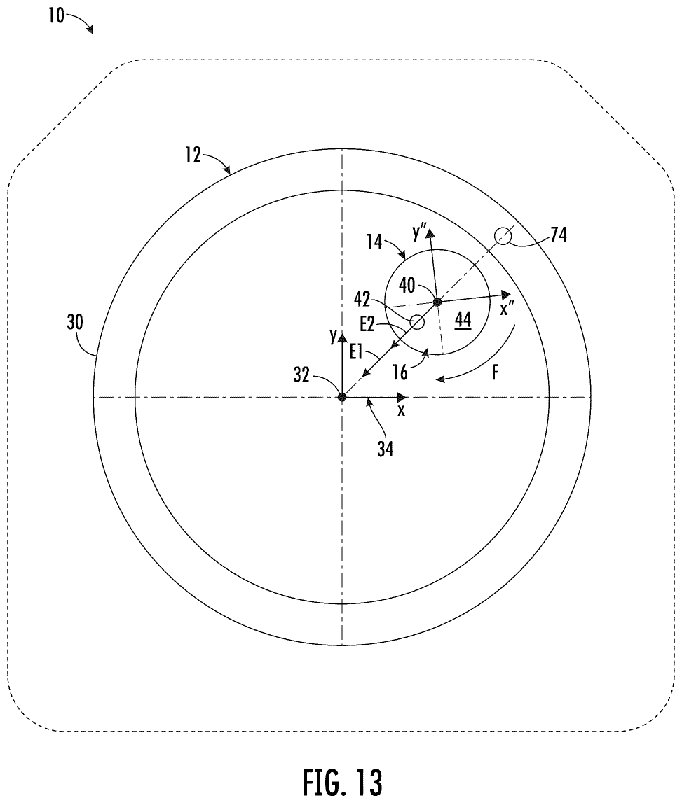

FIG. 13 illustrates the optical fiber 16 positioned within the micro-bore 14 with the ferrule 12 and the optical fiber 16 having an orientation such that the bearing angles α₁ and α₂ are 180 degrees apart. The arrangement of FIG. 13 may be achieved by maintaining the orientation of the ferrule 12 and rotating the optical fiber 16 to achieve a 180-degree difference in the bearing angles α₁, α₂ (demonstrated by arrow F). In a further alternative embodiment (not shown), both the ferrule 12 and the optical fiber 16 may be rotated to achieve the 180-degree difference in the bearing angles α₁, α₂. In a further alternative embodiment (not shown), the orientation of optical fiber 16 is maintained while the ferrule 12 (or alternatively the entire fiber optic connector 10) is rotated about its central axis to achieve a 180-degree difference in the bearing angles α₁, α₂. For example, in one exemplary embodiment, the ferrule 12 may be rotated such that micro-bore 14 is positioned upwardly from the ferrule center 32 (i.e., α₁ is 0 degrees) and the optical fiber 16 may be rotated such that the inner core 42 is positioned downwardly from the fiber center 40 (i.e., α₂ is 180 degrees). In a further embodiment, the ferrule 12 may be rotated before it is installed into the fiber optic connector such that micro-bore 14 is positioned upwardly (or other preferred direction with respect to an orientation key on the fiber optic connector) and the optical fiber 16 may be rotated such that the inner core 42 is positioned opposite to the direction of the micro-bore 14. As described more fully below, the relative rotations between the optical fiber 16 and the ferrule 12 in order to achieve the 180-degree difference in the bearing angles α₁, α₂ may be prior to the insertion of the optical fiber 16 in the micro-bore 14 of the ferrule 12.

The method outlined above takes into account the offset in the position of the micro-bore 14 within the ferrule 12 and the offset of the inner core 42 within the optical fiber 16 to minimize the core-to-ferrule offset. Thus, the inner core 42 is positioned as close as possible to the intended mating location of the ferrule 12 (and fiber optic connector 10) given a particular ferrule 12 and optical fiber 16 pairing. In other words, the inner core 42 is positioned as close as possible to the fixed, known location where the fiber optic connector 10 is expected to connect to another optical component. Thus, it is believed that the insertion losses associated with the optical connection between the fiber optic connector 10 as modified by the present disclosure and the other optical component will be reduced. That is, if the optical component to which the fiber optic connector 10 is configured to mate has also been “optimized” in the manner described above, then it is believed that a further reduction in the insertion losses across the optical connection will be achieved. For example, if the other optical component is another optical connector similar to fiber optic connector 10, then the core-to-ferrule offset for the other fiber optic connector may be similarly minimized. Thus, for each of the fiber optic connectors being mated across the optical connection, the inner cores 42 are as close as possible to their intended mating location and the insertion losses across the optical connection will be reduced, and perhaps significantly reduced, compared to current fiber optic connectors (made according to conventional manufacturing techniques) and randomly mated across an optical connection.

In a further aspect of the present disclosure, the variance as a result of the position of the optical fiber 16 within the micro-bore 14 (i.e., numeral ii) listed above and identified by Axe, Aye (FIG. 9A)) may be reduced or eliminated. It is believed that reducing or eliminating this variance will further reduce the insertion losses across an optical connection. Stated another way, due to the variance, there may be an eccentricity vector still present within connector 10, and additional method(s) may be employed to reduce the eccentricity vector. More particularly, one aspect of the method may include providing an interference fit between the optical fiber 16 and the micro-bore 14. Such an interference fit essentially eliminates any play that might exist in positioning the optical fiber 16 within the micro-bore 14 and any potential offsets as a result of that play. Another aspect of the method may include implementing bulk surface changes to ferrule 12 such that micro-bore 14 engages with optical fiber 16 to reduce the variance of the position of optical fiber 16 within micro-bore 14. In particular, with reference to FIG. 13, the heights of protrusions may be varied (FIGS. 5A and 5B) such that optical fiber 16 is shifted within micro-bore 14 and into a position where the magnitude of eccentricity vector E1 is reduced to a magnitude of eccentricity vector E2 as shown in FIG. 13. Similarly, the shape of micro-bore 14 may be altered (as shown in FIGS. 6A and 6B for example) to shift optical fiber 16 within micro-bore 14 and into a position where the magnitude of eccentricity vector E1 is reduced to a magnitude of eccentricity vector E2 as shown in FIG. 13.

### Examples Relating to Ferrule Assembly 25 and Connector 10

### Example 1

To prepare the laser treated samples in this Example, a nanosecond pulsed fiber laser beam was used to generate bulk modifications near the ferrule micro-bore. The pulsed fiber laser beam had a 30 nanosecond pulse length, a wavelength of about 1950 nm, a frequency of 3 kHz, and a pulse energy of 300 μJ. In addition, the laser beam had a diameter of about 5 mm after passing through a collimator. The laser beam is focused using a lens with an effective focal length of about 6 mm.

The ferrules used in this Example were LC ferrules, and a single mode optical fiber was inserted into the ferrule. The laser beam was incident from side the ferrule (i.e., at an angle perpendicular to an axis of the ferrule). The area of contact by laser beam onto ferrule end face was offset by about 100 microns (in air) from the center of the micro-bore to avoid damaging the fiber with the laser pulses.

The 2 micron laser created a 2 mm laser modified line along the length of the microhole.

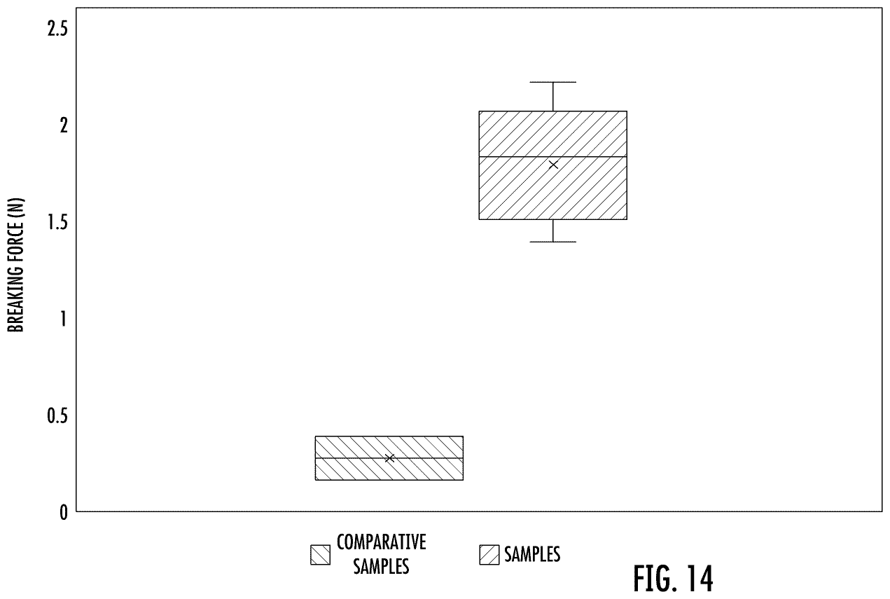

Fifteen (15) samples (hereinafter “Samples”) were prepared consecutively with the above described laser, and the samples were pull-tested in accordance with IEC 61753. The pull test was carried out at a speed of 50 mm/s and the corresponding box-chart distribution of pull strength is shown in FIG. 14. The data was compared to a baseline sample set (referred to as “Comparative Samples”) that was prepared by directly inserting the optical fiber into the ferrule without laser treating the ferrule.

FIG. 14 shows that in comparison with the Comparative Samples, the Samples that were laser treated as described above had a greater median pull strength. In particular, the Comparative Samples had a median pull strength of about 0.3 Newtons (N) and by contrast, the Samples had a median pull strength of 1.8 N indicating an increase of pull strength due to locking the optical fiber with the laser modification around the micro-bore.

### Example 2: Locking of a Fiber in a Ferrule Using a CO Laser Incident from Ferrule End-Face

To prepare laser treated samples, an RF-excited CO laser was used to generate bulk modification in ferrules. The CO laser is a continuous wave (CW) laser that was operated at 100 Hz, a pulse length/width of 1 millisecond (ms), and a pulse energy of 60 mJ. The laser beam was incident perpendicular to the ferrule end-face (i.e., the laser beam was emitted such that the laser beam was parallel to an axis of the ferrule). The laser beam was focused about 0.8 mm below ferrule end-face with a 6 mm (focal length) plan-convex lens.

The ferrules used were SC ferrules and standard single mode fibers were inserted into the SC ferrules (hereinafter referred to as the “Samples”). The area of contact by laser beam onto the Sample was a circumferential modification around the microhole, and the laser beam was offset by about 150 microns from center of the micro-bore. During laser treatment of the Samples, the laser was moved at a speed of 0.2 mm/s along the circular trajectory for 1 revolution.

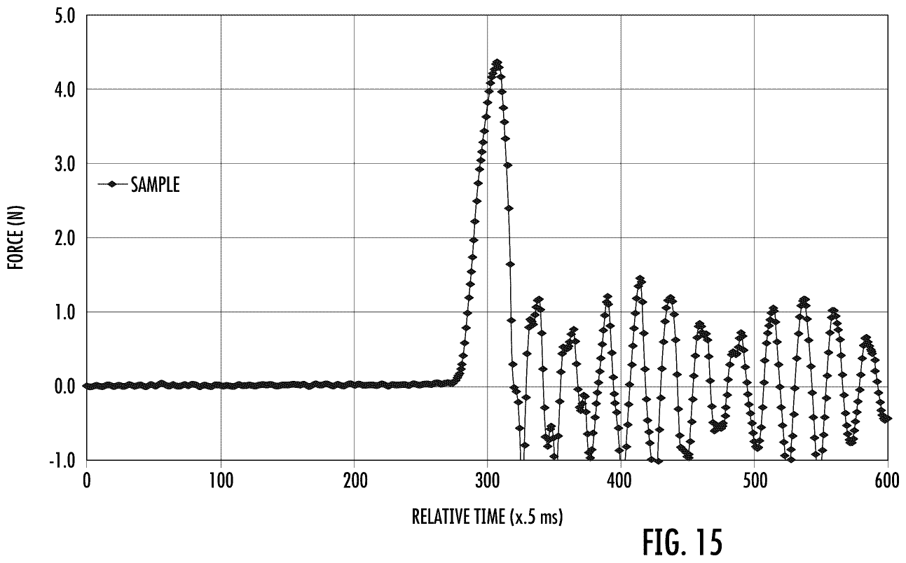

FIG. 15 shows a pull test result for the Samples as measured by IEC 61753. A maximum pull strength of 4.4 Newtons was observed in the laser treated ferrules.

Without wishing to be held to a particular theory, it is believed that optical fiber(s) have a greater absorption of the CO laser wavelength. Thus, it is believed that when laser treating the ferrule with the CO laser beams to lock the optical fiber in the ferrule, the optical fiber absorbs some of the CO laser beams such that the optical fiber undergoes a slight polish and edge rounding without distortion of the fiber core to produce an additional locking effect within the ferrule.

It will be apparent to those skilled in the art that various modifications to the preferred embodiments of the disclosure as described herein can be made without departing from the spirit or scope of the disclosure as defined in the appended claims.

Thus, the disclosure covers the modifications and variations provided they come within the scope of the appended claims and the equivalents thereto.

What is claimed is:

1. A ferrule comprising:
a ferrule body having a front end, a rear end, and a ferrule bore extending between the front end and the rear end;
wherein at least a portion of the ferrule bore comprises a micro-bore;
wherein the ferrule body defines an inner surface of the micro-bore;
wherein the micro-bore comprises at least one protrusion extending from the inner surface of the ferrule bore and towards a longitudinal axis of the ferrule bore.

2. The ferrule of claim 1, wherein the at least one protrusion has a height ranging between 1 micron and 5000 microns relative to the inner surface of the micro-bore.

3. The ferrule of claim 1, wherein the at least one protrusion comprises a plurality of protrusions spaced apart from each other by 90 degrees along the inner surface.

4. The ferrule of claim 1, wherein the at least one protrusion comprises a plurality of protrusions that spans a circumference of the inner surface.

5. The ferrule of claim 1, wherein the at least one protrusion comprises a plurality of protrusions arranged in a helical pattern along a length of the micro-bore.

6. A ferrule assembly of claim 1, wherein the ferrule assembly further comprises:
optical fiber inserted into the micro-bore, wherein the at least one protrusion engages with the optical fiber such that the optical fiber is held in place within the ferrule bore.

7. A ferrule assembly, further comprising:
a ferrule having a front end, a rear end, and a ferrule bore extending between the front end and the rear end, wherein:
at least a portion of the ferrule bore comprises a micro-bore, and
the micro-bore comprises at least one protrusion extending from an inner surface of the ferrule bore and towards a longitudinal axis of the ferrule bore; and
an optical fiber inserted into the micro-bore to define an annular gap between an outer surface of the optical fiber and the inner surface of the micro-bore, the annular gap having a volume;
wherein the at least one protrusion occupies a portion of the volume of the annular gap and contacts the optical fiber.

8. The ferrule assembly of claim 7, wherein the at least one protrusion applies a compressive force onto the optical fiber such that the optical fiber has a pull force of at least 2 pounds-force (lbf) as measured by IEC61753.

9. A method of terminating an optical fiber with a ferrule, wherein the ferrule having a front end, a rear end, and a ferrule bore extending between the front end and the rear end, wherein at least a portion of the ferrule bore defines a micro-bore, the method comprising:
inserting the optical fiber into the micro-bore; and
applying a laser treatment onto the ferrule to create at least one protrusion along an inner surface of the micro-bore wherein the at least one protrusion extends towards a longitudinal axis of the micro-bore.

10. The method of claim 9, wherein an annular gap is defined upon insertion of the optical fiber into the micro-bore, the annular gap is between the inner surface of the micro-bore and the outer surface of the optical fiber;
wherein the at least one protrusion occupies a portion of the volume of the annular gap and contacts the optical fiber.

11. The method of claim 9, wherein the at least one protrusion comprises a plurality of protrusions that spans a circumference of the inner surface.

12. The method of claim 9, wherein the at least one protrusion comprises a plurality of protrusions arranged in a helical pattern along a length of the ferrule bore.

13. The method of claim 9, wherein the at least one protrusion has a height relative to the inner surface of the micro-bore ranging between 1 micron and 5000 microns.

14. The method of claim 9, further comprising:
heating the ferrule such that the micro-bore expands prior to inserting the optical fiber; and
cooling the ferrule such that the micro-bore contracts onto the optical fiber.

15. The method of claim 9, wherein the laser treatment comprises:
irraditating one or more locations on the inner surface of the ferrule bore with a laser beam having a wavelength ranging between 0.3 nm and 20 nm.

16. The method of claim 15, wherein the laser beam has a pulse width between 10 femtoseconds and 100 milliseconds, a repetition rate between 0 kHz and 200 kHz, and a power output of up to 100 W.

17. The method of claim 15, wherein the laser beam is applied onto the inner surface of the micro-bore in a non-orthogonal direction relative to the longitudinal axis of the micro-bore.

18. The method of claim 15, wherein the laser beam is applied onto the inner surface of the micro-bore in a direction orthogonal to the longitudinal axis of the micro-bore.

19. The method of claim 9, wherein the optical fiber has a pull force of at least 2 pounds-force (lbf) as measured by IEC61753.

20. A method of terminating an optical fiber with a fiber optic connector that includes a ferrule having a micro-bore and an end face with a mating location, the method comprising:
inserting the optical fiber into the micro-bore of the ferrule;
orienting the ferrule and the optical fiber relative to each other to minimize distance between the inner core of the optical fiber and the mating location of the ferrule;
applying a laser treatment onto the ferrule to further minimize the distance between the inner core of the optical fiber and the mating location of the ferrule;
heating the ferrule a processing temperature above room temperature; and
with the ferrule at the processing temperature and with the distance between the inner core and the mating location minimized, coupling the optical fiber to the micro-bore of the ferrule.

21. The method of claim 20, wherein the applying a laser treatment step occurs after the optical fiber is coupled to the micro-bore of the ferrule.

22. The method of claim 20, wherein orienting the ferrule and the optical fiber relative to each other further comprises:
fixing the orientation of the optical fiber; and
rotating the ferrule about a longitudinal axis of the ferrule.

23. The method of claim 20, wherein orienting the ferrule and the optical fiber relative to each other comprises:
fixing the orientation of the ferrule; and
rotating the optical fiber about a longitudinal axis of the optical fiber.

24. The method of claim 20, wherein orienting the ferrule and the optical fiber relative to each other comprises rotating the ferrule and the optical fiber about respective central axes of the ferrule and the optical fiber.

25. The method of claim 20, further comprising:
determining a bore bearing angle of a bore offset of the micro-bore in the ferrule at the end face relative to a reference axis;
determining a core bearing angle of a core offset of an inner core in the optical fiber at an end of the optical fiber relative to the reference axis;
wherein orienting the ferrule and the optical fiber relative to each other to minimize the distance between the inner core and the mating location comprises orienting the ferrule and the optical fiber relative to each other so that the bore bearing angle of the bore offset and the core bearing angle of the core offset are 180 degrees apart.

26. The method of claim 25, wherein the applying the laser treatment step comprises altering an inner surface of the micro-bore such that the bore bearing angle of the bore offset and the core bearing angle of the core offset are 180 degrees apart and a magnitude of the bore offset and a magnitude of the core offset are minimized relative to each other.

27. The method of claim 26, wherein the altering step comprises changing the micro-bore from a first shape to a second shape, wherein the first shape has a substantially circular cross section and the second shape has a substantially oval cross section.
